(19) United States
(12) Patent Application Publication
(10) Pub. No.: US 2026/0084163 A1
(43) Pub. Date: Mar. 26, 2026

(54) MICRO NOZZLE CLEANING APPARATUS, MICRO NOZZLE CLEANING METHOD, AND ELECTRONIC DEVICE

(71) Applicant: Samsung Display Co., LTD., Yongin-si (KR)

(72) Inventor: Chan Hae HWANG, Yongin-si (KR)

(21) Appl. No.: 19/213,192

(22) Filed: May 20, 2025

(30) Foreign Application Priority Data
Sep. 26, 2024 (KR) 10-2024-0131047

(51) Int. Cl. B05B 1/34; B08B 7/02; B24C 1/08

(52) U.S. Cl. CPC B05B 1/34; B08B 7/02; B24C 1/08

(57) ABSTRACT

A micro nozzle cleaning apparatus includes a cleaning nozzle for spraying an abrasive slurry containing an abrasive particle onto a micro nozzle, where a diameter of the micro nozzle is 50 micrometers (μm) or less, and a concentration of the abrasive particle is 0.1 volume percent (vol %) to 10 vol %.

This application claims priority to Korean Patent Application No. 10-2024-0131047 filed on Sep. 26, 2024, and all the benefits accruing therefrom under 35 U.S.C. § 119, the content of which in its entirety is herein incorporated by reference.

### BACKGROUND

### 1. Field

The disclosure relates to a micro nozzle cleaning apparatus, a micro nozzle cleaning method, and an electronic device.

### 2. Description of the Related Art

Recently, as interest in an information display has been increasing, research and development on manufacturing equipment of a display device has been continuously conducted.

### SUMMARY

An aspect of the disclosure is to provide a micro nozzle cleaning apparatus and method capable of effectively removing a resin foreign matter of a micro nozzle.

An aspect of the disclosure is not limited to the aspect described above, and other technical aspects which are not described may be clearly understood by those skilled in the art from the description below.

According to an embodiment of the disclosure, a micro nozzle cleaning apparatus includes a cleaning nozzle for spraying an abrasive slurry containing an abrasive particle onto a micro nozzle, where a diameter of the micro nozzle is 50 micrometers (μm) or less, and a concentration of the abrasive particle is 0.1 volume percent (vol %) to 10 vol %.

A distance between an end of the micro nozzle and an end of the cleaning nozzle may be 0.1 millimeters (mm) to 5 mm.

A diameter of the cleaning nozzle may be 0.1 mm to 2 mm.

A spray pressure of the cleaning nozzle may be 20 bar or more.

The micro nozzle cleaning apparatus may further include a nozzle receiving unit positioned under the micro nozzle.

The nozzle receiving unit may include a shatter resistant cover surrounding the cleaning nozzle.

The nozzle receiving unit may further include a gasket, which is in contact with a lower portion of the micro nozzle.

The micro nozzle cleaning apparatus may further include a storage unit for storing the abrasive slurry.

An average diameter of the abrasive particle may be sub-micron (0.1 μm) to 6 μm.

The abrasive particle may include a colloidal inorganic particle.

The abrasive particle may include at least one of FeO, Fe₂O₃, Fe₃O₄, CeO₂, SiC, SiO₂, ZrO₂, or Al₂O₃.

The abrasive slurry may include water and/or glycerin.

The abrasive slurry may further include a surfactant and/or a dispersant.

According to an embodiment of the disclosure, in a micro nozzle cleaning method, an abrasive slurry containing an abrasive particle is sprayed, and a resin foreign matter is separated from an end of a micro nozzle of a jetting dispenser by the spread abrasive slurry, in order to remove the resin foreign matter, which is hardened, from the end of the micro nozzle in a process in which resin is ejected through the micro nozzle.

A diameter of the micro nozzle may be 50 μm or less.

A spray time of the abrasive slurry may be within 3 seconds.

A concentration of the abrasive particle may be 0.1 vol % to 10 vol %.

A spray pressure of the abrasive slurry may be 20 bar or more.

An average diameter of the abrasive particle may be sub-micron (0.1 μm) to 6 μm.

The abrasive particle may include a colloidal inorganic particle.

Specific details of other embodiments are included in the detailed description and drawings.

According to an embodiment of the disclosure, an electronic device includes a processor to provide input image data, and a display device to display an image based on the input image data, where the display device is manufactured using a jetting dispenser comprising a micro nozzle, the micro nozzle cleaning apparatus comprises a cleaning nozzle for spraying an abrasive slurry containing an abrasive particle onto a micro nozzle, and a diameter of the micro nozzle is 50 μm or less, and a concentration of the abrasive particle is 0.1 vol % to 10 vol %.

According to an embodiment described above, the micro nozzle may be cleaned using the abrasive slurry.

An effect according to embodiments is not limited to the content exemplified above, and more various effects are included in the present specification.

### BRIEF DESCRIPTION OF THE DRAWINGS

The above and other features of the disclosure will become more apparent by describing in further detail embodiments thereof with reference to the accompanying drawings, in which:

FIG. 1 is a side view of a jetting dispenser according to an embodiment;

FIG. 2 is a plan view of a micro nozzle according to an embodiment;

FIG. 3 is a side view of a micro nozzle according to an embodiment;

FIG. 4 is a side view of a micro nozzle cleaning apparatus according to an embodiment;

FIGS. 5 to 7 are side views for each process step of a micro nozzle cleaning method according to an embodiment; and

FIGS. 8 and 9 are exemplary drawings illustrating micro nozzles cleaned by a micro nozzle cleaning apparatus and method according to an embodiment.

FIG. 10 is a block diagram of an electronic device according to an embodiment.

FIG. 11 shows schematic views of various embodiments of an electronic device.

### DETAILED DESCRIPTION

The advantages and features of the disclosure and a method of achieving them will become apparent with reference to the embodiments described in detail below together with the accompanying drawings. However, the disclosure is not limited to the embodiments disclosed below, and may be implemented in various different forms.

The present embodiments are provided so that the disclosure will be thorough and complete and those skilled in the art to which the disclosure pertains can fully understand the scope of the disclosure. The disclosure is only defined by the scope of the claims.

The term used in the present specification is for describing embodiments and is not intended to limit the disclosure. In the present specification, the singular form also includes the plural form unless otherwise specified. “Or” means “and/or.” As used herein, the term “and/or” includes any and all combinations of one or more of the associated listed items.

The term “comprises” and/or “comprising” does not exclude presence or addition of one or more other components, steps, operations, and/or elements to the described component, step, operation, and/or element.

The term “coupling” or “connection” may collectively mean a physical and/or electrical coupling or connection. This may collectively mean a direct or indirect coupling or connection and an integral or non-integral coupling or connection.

A case in which elements or layers are referred to as “on” another element or layer includes a case in which another layer or another element is disposed directly on the other element or between the other layers. The same reference numerals denote to the same components throughout the specification.

Although a “first”, a “second”, and the like are used to describe various components, these components are not limited by these terms. These terms are used only to distinguish one component from another component. Therefore, a first component described below may be a second component within the technical spirit of the disclosure.

Throughout the disclosure, the expression “at least one of a, b or c” indicates only a, only b, only c, both a and b, both a and c, both b and c, all of a, b, and c, or variations thereof. Hereinafter, embodiments of the disclosure are described in detail with reference to the accompanying drawings.

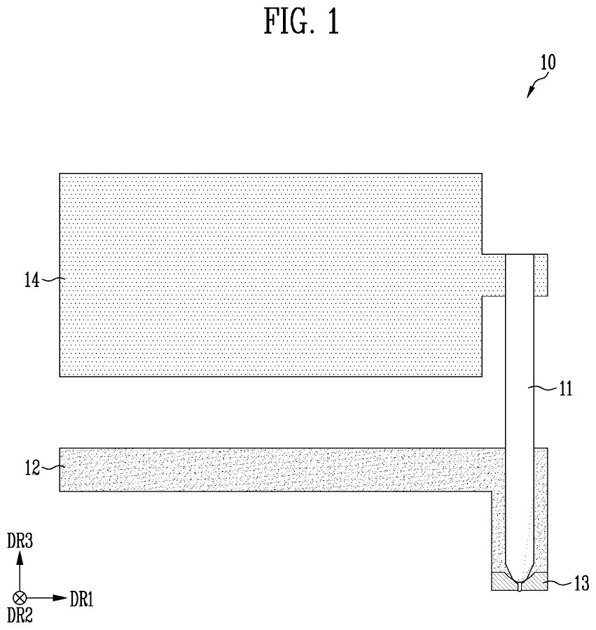

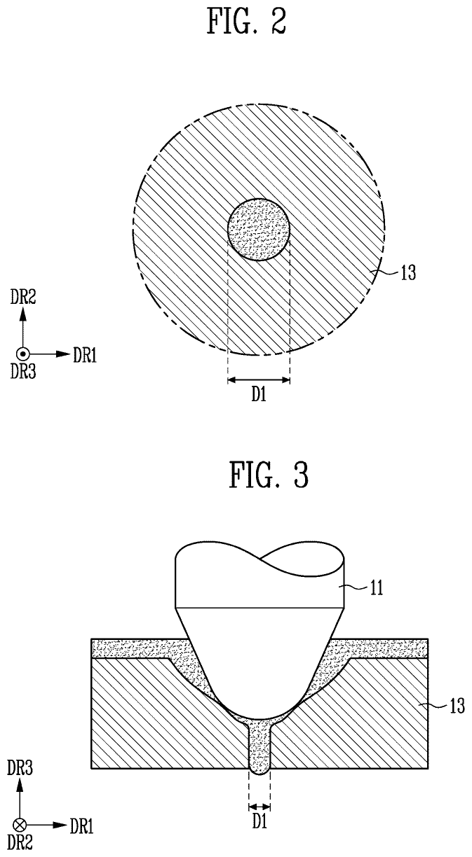

FIG. 1 is a side view of a jetting dispenser according to an embodiment. FIG. 2 is a plan view of a micro nozzle according to an embodiment. FIG. 3 is a side view of a micro nozzle according to an embodiment.

The jetting dispenser 10 is a manufacturing apparatus of a display device, and may discharge and apply a solution (for example, resin) on a substrate of the display device using the jetting dispenser 10.

The jetting dispenser 10 may be used in manufacturing of an electronic device to which a display surface is applied to at least one surface, such as a smartphone, a television, a laptop, a tablet PC, an electronic device, a computing system, a display system, a smart glasses, an HMD, or a vehicle display device.

Referring to FIGS. 1 to 3, the jetting dispenser 10 may include a needle 11, a flow path 12, a micro nozzle 13, and/or a piezo element 14.

The needle 11 may be configured to be able to move up and down. For example, the needle 11 may be repeatedly moved up and down by repeatedly applying and blocking a voltage to the piezo element 14, and the solution may be discharged according to the number of times the needle 11 moves up and down.

The needle 11 may discharge the solution filled in the flow path 12. The needle 11 may serve to push the solution so that the solution filled in the flow path 12 may be discharged through the micro nozzle 13.

According to an embodiment, a sensor module that sets an operation range of the needle 11 may be further provided. The sensor module may determine a maximum operation range when the needle 11 is initially driven and operate the needle 11 in the maximum operation range, thereby preventing the needle 11 from being damaged by excessively descending and colliding with the micro nozzle 13.

According to an embodiment, the jetting dispenser 10 may further include a conversion member. One side of the conversion member may be provided on one side of the piezo element, and another side of the conversion member may be provided on one side of the needle 11.

When a voltage is applied to the piezo element 14, the piezo element 14 may expand, a direction of energy generated by the expansion of the piezo element 14 may be converted by the conversion member and transferred to the needle 11, the needle 11 may descend in a downward direction, and the solution may be discharged through a discharge port of the micro nozzle 13.

When the voltage applied to the piezo element 14 is cut off, the piezo element 14 may contract, and the needle 11 may ascend in an upward direction and may be restored to an original position.

However, an operation method of the conversion member is not necessarily limited thereto, and the conversion member may be omitted according to a disposition of the piezo element 14 and the needle 11.

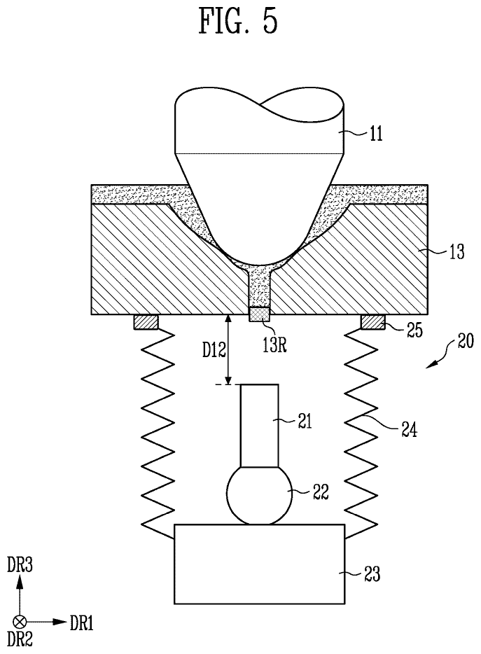

A diameter D1 of the micro nozzle 13 may be 50 μm or less. For fine application, the diameter D1 of the micro nozzle 13 may be 40 μm or less. As described above, the jetting dispenser 10 provided with the micro nozzle 13 enables precise fine application, thereby reducing a dead space of the display device and implementing a high-resolution display device. However, as the diameter of the micro nozzle 13 is reduced, the micro nozzle 13 may be vulnerable to nozzle clogging and cleaning by a resin foreign matter. In addition, when cleaning of the micro nozzle 13 clogged by the resin foreign matter is impossible, productivity may be reduced, such as occurrence of quality dispersion until the micro nozzle 13 is replaced and stabilized. For example, in a case of the micro nozzle 13, cleaning using a microscope and a needle pin may be impossible, and cleaning may be performed using a resin solvent and an ultrasonic wave, but a cleaning effect may be minimal due to limitation of cleaning power. Accordingly, a micro nozzle cleaning apparatus 20 according to an embodiment may easily remove the resin foreign matter of the micro nozzle 13 within a short period of time using an abrasive slurry without stopping an operation of the jetting dispenser 10. A detailed description thereof is described later with reference to FIGS. 5 to 9.

According to an embodiment, the jetting dispenser 10 may further include a supply unit. The supply unit may supply the solution to the flow path 12. The supply unit may be a solution tank in which the solution is filled inside. The solution supplied from the supply unit may be filled in the flow path 12 and discharged to an outside through the micro nozzle 13.

According to an embodiment, a compressor that generates pressure inside the supply unit may be further provided on the supply unit. For example, the solution filled in the supply unit may be moved to the flow path 12, which is to be described later, by pressure of an air generated from the compressor. According to an embodiment, the compressor may be omitted.

The piezo element 14 may be contracted or expanded by the applied voltage. The solution filled in the path 12 may be discharged to the outside through the discharge port of the micro nozzle 13 by the contraction or expansion of the piezo element 14.

According to an embodiment, the jetting dispenser 10 may further include a control unit that supplies the voltage to the piezo element 14. The control unit may adjust the flow rate of the solution discharged through the micro nozzle 13 according to a length change of the piezo element 14 by supplying the voltage to the piezo element 14 to cause the piezo element 14 to contract or expand. The jetting dispenser 10 described above may implement fast response, quantitative discharge, and accurate injection rate by using a piezoelectric property of the piezo element 14, that is, a property of contracting or expanding when a voltage is applied.

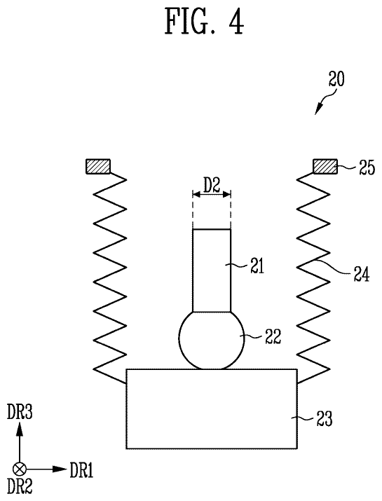

FIG. 4 is a side view of a micro nozzle cleaning apparatus according to an embodiment.

Referring to FIG. 4, the micro nozzle cleaning apparatus 20 may include a cleaning nozzle 21, a pump 22, a storage unit 23, and/or a nozzle receiving unit 24 and 25.

An abrasive slurry in the storage unit 23 may be supplied by the pump 22 and sprayed through the cleaning nozzle 21. The cleaning nozzle 21 may spray the abrasive slurry onto the micro nozzle 13 to clean the micro nozzle 13. The abrasive slurry sprayed from the cleaning nozzle 21 may directly contact or rub against a hardened resin foreign matter at the discharge port or the end of the micro nozzle 13 to separate the resin foreign matter.

A diameter D2 of the cleaning nozzle 21 may be 2 mm or less. For example, the diameter D2 of the cleaning nozzle 21 may be 0.1 mm to 2 mm, but is not necessarily limited thereto.

The abrasive slurry may include an abrasive particle dispersed in water and/or glycerin. A concentration of the abrasive particle of the abrasive slurry may be 0.1 vol % to 10 vol %. When the concentration of the abrasive particle of the abrasive slurry is excessively low or high, a cleaning effect may be reduced.

An average diameter of the abrasive particle may be sub-micron (0.1 μm) to 6 μm. When the average diameter of the abrasive particle is excessively small or large, the cleaning effect may be minimal and may affect the micro nozzle 13. However, the concentration and the average diameter of the abrasive particle are not necessarily limited thereto, and may be variously changed within a range that may effectively remove the resin foreign matter of the micro nozzle 13.

In an embodiment, the abrasive particle may be in a colloid state. For example, the abrasive particle may include a colloidal inorganic particle. The abrasive particle may include a colloidal silica particle, but is not necessarily limited thereto. The abrasive particle may include at least one of FeO, Fe₂O₃, Fe₃O₄, CeO₂, SiC, SiO₂, ZrO₂, or Al₂O₃, but is not necessarily limited thereto. According to an embodiment, the abrasive slurry may further include a surfactant and/or a dispersant.

The nozzle receiving unit 24 and 25 may surround the cleaning nozzle 21. The nozzle receiving unit 24 and 25 may at least partially surround the pump 22 and/or the storage unit 23. The nozzle receiving unit 24 and 25 may provide a space in which the micro nozzle 13 of the jetting dispenser 10 may be received. The nozzle receiving unit 24 and 25 may be disposed under the micro nozzle 13. One side of the nozzle receiving unit 24 and 25 may be adjacent to the storage unit 23. Another side of the nozzle receiving unit 24 and 25 may be adjacent to the micro nozzle 13.

In an embodiment, the nozzle receiving unit 24 and 25 may include a shatter resistance cover 24 and a gasket 25. The shatter resistant cover 24 may at least partially surround the cleaning nozzle 21, the pump 22, and/or the storage unit 23. The shatter resistant cover 24 may provide a space in which the micro nozzle 13 of the jetting dispenser 10 may be received.

One side of the shatter resistant cover 24 may be adjacent to the storage unit 23. Another side of the shatter resistant cover 24 may be connected to the gasket 25. The gasket 25 may be adjacent to a lower portion of the micro nozzle 13. For example, the gasket 25 may be in contact with the lower portion of the micro nozzle 13. The gasket 25 may be fixed to the lower portion of the micro nozzle 13, but is not necessarily limited thereto.

Continuously, a micro nozzle cleaning method using the micro nozzle cleaning apparatus according to the embodiment described above is described.

FIGS. 5 to 7 are side views for each process step of a micro nozzle cleaning method according to an embodiment. FIGS. 5 to 7 are side views for describing a micro nozzle cleaning method using the micro nozzle cleaning apparatus 20 of FIG. 4. For convenience of description, the micro nozzle cleaning method is simply shown and a detailed symbol is omitted.

Referring to FIG. 5, first, in a process of discharging resin or the like from the micro nozzle 13, the resin may remain in the discharge port or the end of the micro nozzle 13. When the resin remaining in the discharge port of the micro nozzle 13 is exposed to a light source, the resin may be easily hardened. In this case, the discharge port of the micro nozzle 13 may become narrow due to a hardened resin foreign matter 13R in the discharge port of the micro nozzle 13. Accordingly, a flow discharged from the micro nozzle 13 may be reduced or unstably fluctuated, a defect may be induced, and as a result, the discharge port of the micro nozzle 13 may be completely blocked by the resin foreign matter 13R.

The micro nozzle cleaning apparatus 20 may be moved to a position of the micro nozzle 13 blocked by the resin foreign matter 13R and positioned under the micro nozzle 13. An end of the cleaning nozzle 21 may be disposed toward the end of the micro nozzle 13. The end of the cleaning nozzle 21 may face the discharge port or the end of the micro nozzle 13 in a vertical direction (for example, in a third direction DR3). A distance D12 of the vertical direction (for example, in the third direction DR3) between the end of the cleaning nozzle 21 and the end of the micro nozzle 13 may be 0.1 mm to 5 mm. However, the distance D12 is not necessarily limited thereto, and may be variously changed within a range in which the abrasive slurry sprayed from the cleaning nozzle 21 may be removed from the micro nozzle 13 by contacting or rubbing against the resin foreign matter 13R. According to an embodiment, the micro nozzle cleaning apparatus 20 may further include a height adjustment unit that moves the cleaning nozzle 21 up and down to adjust the distance D12 of the vertical direction (for example, the third direction DR3) between the end of the cleaning nozzle 21 and the end of the micro nozzle 13.

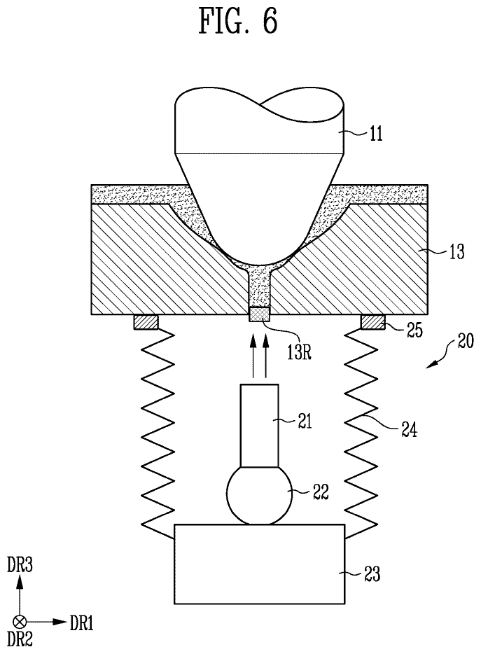

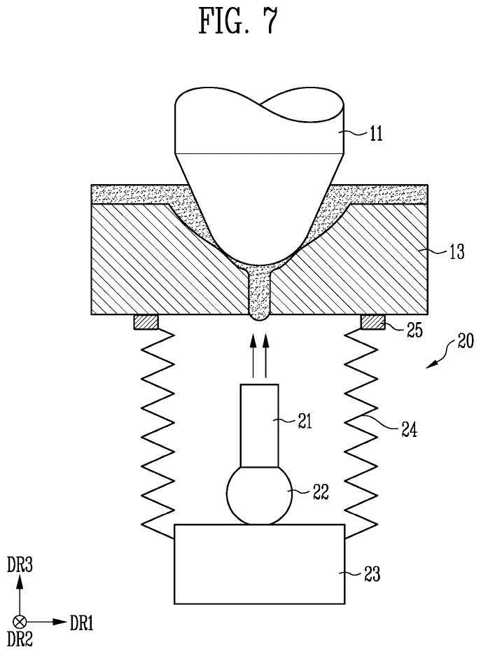

Referring to FIGS. 6 and 7, subsequently, the abrasive slurry is sprayed to remove the resin foreign matter 13R hardened at the discharge port or the end of the micro nozzle 13. The abrasive slurry in the storage unit 23 may be supplied by the pump 22 and sprayed through the cleaning nozzle 21. The resin foreign matter 13R may be separated and removed from the discharge port or the end of the micro nozzle 13 by the abrasive slurry sprayed through the cleaning nozzle 21.

The abrasive slurry may include the abrasive particle dispersed in water and/or glycerin. The concentration of the abrasive particle of the abrasive slurry may be 0.1 vol % to 10 vol %. When the concentration of the abrasive particle of the abrasive slurry is excessively low or high, a cleaning effect may be reduced.

The average diameter of the abrasive particle may be sub-micron (0.1 μm) to 6 μm. When the average diameter of the abrasive particle is excessively small or large, the cleaning effect may be minimal and may affect the micro nozzle 13. However, the concentration and the average diameter of the abrasive particle are not necessarily limited thereto, and may be variously changed within a range that may effectively remove the resin foreign matter of the micro nozzle 13.

In an embodiment, the abrasive particle may be in a colloid state. For example, the abrasive particle may include a colloidal inorganic particle. The abrasive particle may include a colloidal silica particle, but is not necessarily limited thereto. The abrasive particle may include at least one of FeO, Fe₂O₃, Fe₃O₄, CeO₂, SiC, SiO₂, ZrO₂, or Al₂O₃, but is not necessarily limited thereto. According to an embodiment, the abrasive slurry may further include a surfactant and/or a dispersant.

A spray pressure of the cleaning nozzle 21 may be 20 bar or more. For example, the spray pressure of the cleaning nozzle 21 may be 20 bar to 300 bar. However, the spray pressure of the cleaning nozzle 21 is not necessarily limited thereto, and may be variously changed within a range in which the resin foreign matter 13R may be removed by the abrasive slurry sprayed from the cleaning nozzle 21.

In an embodiment, an abrasive slurry spray time of the cleaning nozzle 21 may be within 3 seconds in order to remove the resin foreign matter 13R without affecting the micro nozzle 13. However, the spray time of the abrasive slurry is not necessarily limited thereto, and may be variously changed within a range in which the resin foreign matter 13R may be removed without affecting the micro nozzle 13. According to an embodiment, the micro nozzle cleaning apparatus 20 may further include a control unit for controlling a spray time point or time of the abrasive slurry.

In FIGS. 5 to 7, a method of cleaning the micro nozzle 13 of the jetting dispenser 10 using the piezo element 14 is exemplified, but the disclosure is not necessarily limited thereto, and may be applied to all fields in which a micro nozzle is applied, such as a solenoid, a pneumatic dispenser, and an air spray.

According to the micro nozzle cleaning method described above, the resin foreign matter 13R of the micro nozzle 13 may be removed and cleaned within a short period of time without stopping an operation of the jetting dispenser 10 by spraying the abrasive slurry onto the micro nozzle 13. Therefore, since nozzle replacement may be unnecessary and setting and the like additionally required after nozzle replacement may be omitted, productivity may be improved.

In addition, since the micro nozzle cleaning apparatus 20 according to an embodiment may remove the resin foreign matter 13R hardened at the discharge port of the micro nozzle 13 without a precise alignment device, an equipment cost may be reduced and convenience may be improved.

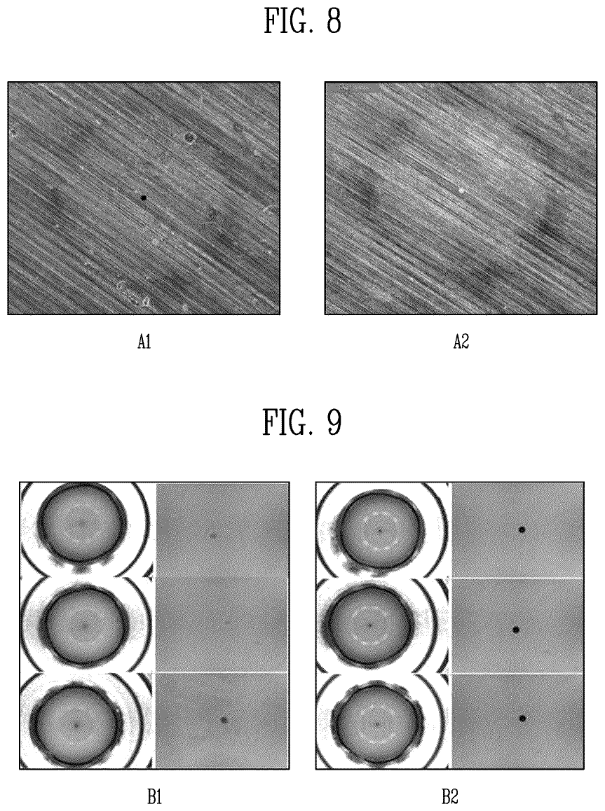

FIGS. 8 and 9 are exemplary drawings illustrating micro nozzles cleaned by the micro nozzle cleaning apparatus and method according to an embodiment. FIG. 8 illustrates before (A1) and after (A2) cleaning of a micro nozzle of which the diameter is 35 μm, and FIG. 9 illustrates before (B1) and after (B2) cleaning of the micro nozzle of which the diameter is 50 μm.

Referring to FIGS. 8 and 9, it may be confirmed that the resin foreign matter is removed and micro nozzle clogging is improved by the micro nozzle cleaning apparatus 20 and method according to an embodiment.

A display device according to an embodiment is applicable to various types of electronic devices. In an embodiment, an electronic device includes the above-described display device and may further include other modules or devices having additional functions in addition to the display device.

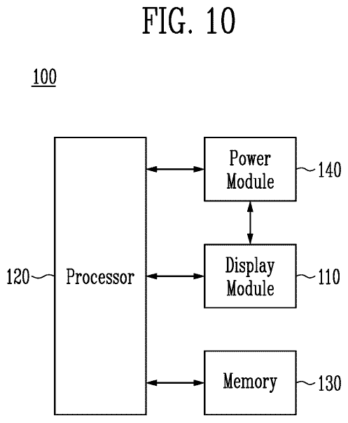

FIG. 10 is a block diagram of an electronic device according to an embodiment. Referring to FIG. 10, the electronic device 100 may include a display module 110, a processor 120, a memory 130, and a power module 140.

The processor 120 may include at least one of a central processing unit (CPU), an application processor (AP), a graphic processing unit (GPU), a communication processor (CP), an image signal processor (ISP), or a controller.

The memory 130 may store data and/or information used to operate the processor 120 or the display module 110. When the processor 120 executes an application stored in the memory 130, image data signals and/or input control signals may be transferred to the display module 110. The display module 110 may process the provided signals and output image information on a display screen.

The power module 140 may include a power supply module, such as a power adapter or a battery device, and a power conversion module. The power conversion module converts power supplied by the power supply module and generates power to operate the electronic device 100.

At least one of the above-described components of the electronic device 100 may be included in the display device according to embodiments as described above. In addition, in terms of functionality, some of the individual modules included in one module may be included in the display device and others may be provided separately from the display device. For example, the display module 110 is included in the display device, whereas the processor 120, the memory 130, and the power module 140 are not included in the display device and are instead provided separately in the electronic device 100.

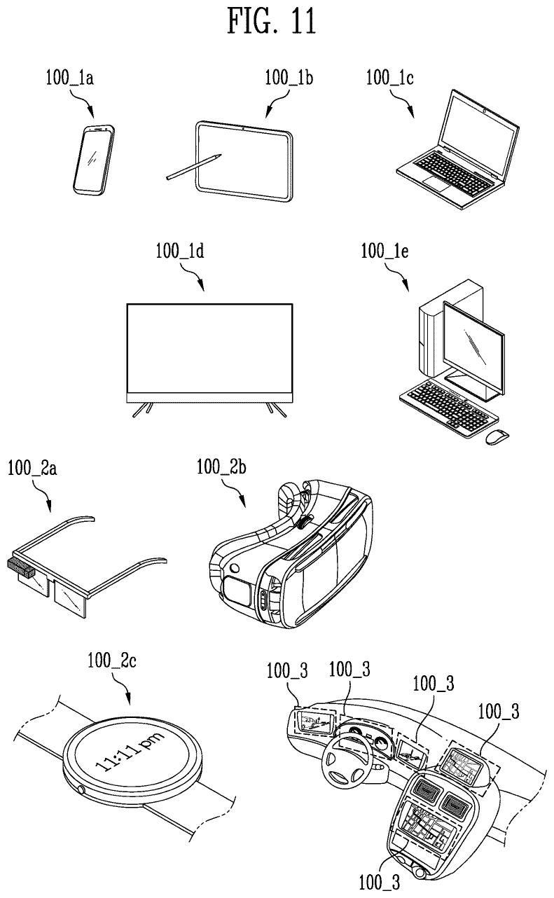

FIG. 11 shows schematic views of various embodiments of an electronic device.

Referring to FIG. 11, various types of electronic devices to which embodiments of a display device are applied may include an electronic device to display images such as a smartphone 100_1a, a tablet PC 100_1b, a laptop computer 100_1c, a television (TV) 100_1d, and a desktop monitor 100_1e, a wearable electronic device including a display module such as smart glasses 100_2a, a head-mounted display (HMD) 100_2b, and a smart watch 100_2c, and an automotive electronic device 100_3 including a display module such as a center information display (CID) disposed at the instrument cluster, the center fascia, and the dashboard of a vehicle, and a room mirror display.

Those skilled in the art may understand that the disclosure may be implemented in a modified form without departing from the above-described essential characteristic. Therefore, the disclosed methods should be considered in a description point of view not a limitation point of view. The scope of the disclosure is shown in the claims not in the above description, and all differences within the scope will be construed as being included in the disclosure.

What is claimed is:

1. A micro nozzle cleaning apparatus comprising:
a cleaning nozzle for spraying an abrasive slurry containing an abrasive particle onto a micro nozzle,
wherein a diameter of the micro nozzle is 50 micrometers (μm) or less, and
a concentration of the abrasive particle is 0.1 volume percent (vol %) to 10 vol %.

2. The micro nozzle cleaning apparatus according to claim 1, wherein a distance between an end of the micro nozzle and an end of the cleaning nozzle is 0.1 millimeters (mm) to 5 mm.

3. The micro nozzle cleaning apparatus according to claim 1, wherein a diameter of the cleaning nozzle is 0.1 mm to 2 mm.

4. The micro nozzle cleaning apparatus according to claim 1, wherein a spray pressure of the cleaning nozzle is 20 bar or more.

5. The micro nozzle cleaning apparatus according to claim 1, further comprising:
a nozzle receiving unit positioned under the micro nozzle.

6. The micro nozzle cleaning apparatus according to claim 5, wherein the nozzle receiving unit includes a shatter resistant cover surrounding the cleaning nozzle.

7. The micro nozzle cleaning apparatus according to claim 5, wherein the nozzle receiving unit includes a gasket, which is in contact with a lower portion of the micro nozzle.

8. The micro nozzle cleaning apparatus according to claim 1, further comprising:
a storage unit for storing the abrasive slurry.

9. The micro nozzle cleaning apparatus according to claim 1, wherein an average diameter of the abrasive particle is 0.1 μm to 6 μm.

10. The micro nozzle cleaning apparatus according to claim 1, wherein the abrasive particle includes a colloidal inorganic particle.

11. The micro nozzle cleaning apparatus according to claim 1, wherein the abrasive particle includes at least one of FeO, Fe₂O₃, Fe₃O₄, CeO₂, SiC, SiO₂, ZrO₂, or Al₂O₃.

12. The micro nozzle cleaning apparatus according to claim 1, wherein the abrasive slurry includes water and/or glycerin.

13. The micro nozzle cleaning apparatus according to claim 12, wherein the abrasive slurry further includes a surfactant and/or a dispersant.

14. A micro nozzle cleaning method in which an abrasive slurry containing an abrasive particle is sprayed, and a resin foreign matter is separated from an end of a micro nozzle of a jetting dispenser by the sprayed abrasive slurry, in order to remove the resin foreign matter, which is hardened, from the end of the micro nozzle in a process in which resin is ejected through the micro nozzle.

15. The micro nozzle cleaning method according to claim 14, wherein a diameter of the micro nozzle is 50 μm or less.

16. The micro nozzle cleaning method according to claim 14, wherein a spray time of the abrasive slurry is within 3 seconds.

17. The micro nozzle cleaning method according to claim 14, wherein a concentration of the abrasive particle is 0.1 vol % to 10 vol %.

18. The micro nozzle cleaning method according to claim 14, wherein a spray pressure of the abrasive slurry is 20 bar or more.

19. The micro nozzle cleaning method according to claim 14, wherein an average diameter of the abrasive particle is 0.1 μm to 6 μm.

20. An electronic device comprising:
a processor to provide input image data; and
a display device to display an image based on the input image data,
wherein the display device is manufactured using a jetting dispenser comprising a micro nozzle,
wherein the micro nozzle cleaning apparatus comprises:
a cleaning nozzle for spraying an abrasive slurry containing an abrasive particle onto a micro nozzle,
wherein a diameter of the micro nozzle is 50 μm or less, and
a concentration of the abrasive particle is 0.1 vol % to 10 vol %.
